(19) United States
(12) Patent Application Publication
(10) Pub. No.: US 2023/0312976 A1
(43) Pub. Date: Oct. 5, 2023

(54) A POLYISOCYANATE COMPOSITION AND A POLYURETHANE COMPOSITION OBTAINED THEREFROM

(71) Applicant: Huntsman International LLC, The Woodlands, TX (US)

(72) Inventors: Bao LUAN, Shanghai (CN); Zhuxia RONG, Shanghai (CN); Sixuan DU, Shanghai (CN)

(21) Appl. No.: 18/023,989

(22) PCT Filed: Sep. 1, 2020
(86) PCT No.: PCT/CN2020/112775

§ 371 Date: Feb. 28, 2023

(51) Int. Cl. C09D 175/08; C08G 18/18; C08G 18/73; C08G 18/24; C08G 18/75

(52) U.S. Cl. CPC C09D 175/08; C08G 18/1875; C08G 18/735; C08G 18/246; C08G 18/757; C08G 2150/00

(57) ABSTRACT

This disclosure generally provides polyfunctional isocyanate compositions and polyurethane compositions made thereof which has improved impact resistance, wherein the polyfunctional isocyanate composition comprising a polyfunctional isocyanate compound which is a derivative of an ether based diisocyanate; wherein the functionality of the polyfunctional isocyanate compound is 3.

### FIELD OF THE INVENTION

This invention relates generally to polyisocyanate compositions and more specially to ether based polyisocyanate compositions used in polyurethane coatings.

### BACKGROUND INFORMATION

Ether based diisocyanate is already known in the art.

JP4032298B disclosed a urethane elastomer based on 1,2-bis (2-isocyanate ethoxy) ethane, which is an ether-containing diisocyanate. But 1,2-bis (2-isocyanate ethoxy) ethane monomer has high volatility and toxicity.

JP3885531B disclosed an aqueous emulsion obtained by using 1,2-bis (2-isocyanate ethoxy) ethane.

However, known solutions are not able to provide a polyfunctional isocyanate composition suitable for use in coating application with high flexibility and superior impact resistance.

### SUMMARY OF THE INVENTION

It has now been surprisingly found that the compositions and processes of the present disclosure address the above problem. Advantages of the present disclosure may include: (1) high flexibility; (2) improved impact resistance; and (3) environmentally friendly.

The present disclosure is concerned with compositions with improved impact resistance. In one embodiment, the disclosure provides a polyfunctional isocyanate composition comprising a polyfunctional isocyanate compound which is a derivative of an ether based diisocyanate; wherein the functionality of the polyfunctional isocyanate compound is 3.

In another embodiment, the present disclosure provides a polyurethane composition comprising: (a) a polyfunctional isocyanate composition; and (b) an isocyanate reactive composition.

In still another embodiment, the present disclosure provides a process for making the polyurethane composition, comprising adding isocyanate reactive composition to a polyfunctional isocyanate composition.

In yet another embodiment, the present disclosure provides a method of using the polyurethane compositions to form a coating product.

In yet another embodiment, the present disclosure provides a coating product comprises the polyurethane composition.

### DETAILED DESCRIPTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of,” if used, excludes any component, step or procedure not specifically delineated or listed. The term “or,” unless stated otherwise, refers to the listed members individually as well as in any combination.

The articles “a” and “an” are used herein to refer to one or to more than one (i.e., to at least one) of the grammatical object of the article. By way of example, “a resin” means one resin or more than one resin.

The phrases “in one embodiment,” “according to one embodiment,” and the like generally mean the particular feature, structure, or characteristic following the phrase is included in at least one embodiment of the present invention and may be included in more than one embodiment of the present invention. Importantly, such phrases do not necessarily refer to the same embodiment.

If the specification states a component or feature “may,” “can,” “could,” or “might” be included or have a characteristic, that particular component or feature is not required to be included or have the characteristic.

Molecular weight (MW) is weight average molecular weight which is defined by Gel Permeation Chromatography (GPC) method with polystyrene as a reference.

The present disclosure generally provides a polyfunctional isocyanate composition comprising a polyfunctional isocyanate compound which is a derivative of an ether based diisocyanate; wherein the functionality of the polyfunctional isocyanate compound is 3.

In one embodiment, the polyfunctional isocyanate compound has the formula (I) or (II):

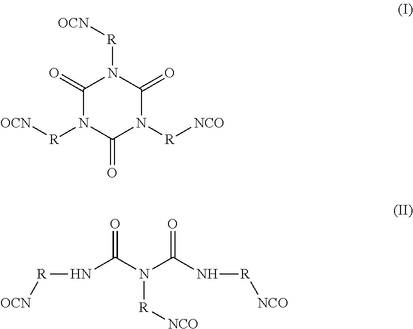

wherein
each R is independently of one another selected from a combination of linear, branched, saturated, unsaturated, cyclic and/or non-cyclic aliphatic hydrocarbons containing at least one ether group, and mixtures thereof.

According to a preferred embodiment, R is linear aliphatic hydrocarbon containing two ether groups.

Those skilled in the art will recognize that it is also possible to use mixtures of the polyfunctional isocyanate compounds described above.

The present disclosure also provides a polyurethane composition comprising: (a) a polyfunctional isocyanate composition of the present disclosure; and (b) an isocyanate reactive composition.

The isocyanate reactive composition suitable for use in the present disclosure may include polyfunctional polyol or polyfunctional amine.

The polyfunctional polyols for use in the present disclosure may include, but are not limited to, polyether polyols, polyester polyols, or an acrylic polyol. Such polyols may be used alone or in suitable combination as a mixture.

OH content of polyfunctional polyols used in the present disclosure may be in an amount ranging from 0.5% to 15%, preferably from 1% to 10%. OH content is the weight percent of OH groups in a molecular.

Polyether polyols for use in the present disclosure include alkylene oxide polyether polyols such as ethylene oxide polyether polyols and propylene oxide polyether polyols and copolymers of ethylene and propylene oxide with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols for use in the present disclosure include, but are not limited to, those produced by reacting a dicarboxylic acid with an excess of a diol, for example, adipic acid with ethylene glycol or butanediol, or reaction of a lactone with an excess of a diol such as caprolactone with propylene glycol. In addition, polyester polyols for use in the present disclosure may also include linear or lightly branched aliphatic (mainly adipates) polyols with terminal hydroxyl group; low molecular weight aromatic polyesters; polycaprolactones; polycarbonate polyol. Those linear or lightly branched aliphatic(mainly adipates) polyols with terminal hydroxyl group are produced by reacting a dicarboxyl acids with an excess of diols, triols and their mixture; those dicarboxyl acids include, but are not limited to, for example, adipic acid, AGS mixed acid; those diols, triols include, but are not limited to, for example, ethylene glycol, diethylene glycol, propylene glycol, dipropylene glycol, 1,4-butane diol, 1,6-hexane diol, glycerol, trimethylolpropane and pentaerythritol. Those low molecular weight aromatic polyesters include products derived from the process residues of dimethyl terephalate (DMT) production, commonly referred to as DMT still bottoms, products derived from the glycolysis of recycled poly(ethyleneterephthalate) (PET) bottles or magnetic tape with subsequent re-esterification with di-acids or reaction with alkylene oxides, and products derived by the directed esterification of phthalic anhydride. Polycaprolactones are produced by the ring opening of caprolactones in the presence of an initiator and catalyst. The initiator includes ethylene glycol, diethylene glycol, propylene glycol, dipropylene glycol, 1,4-butane diol, 1,6-hexane diol, glycerol, trimethylolpropane and pentaerythritol. Polycarbonate polyols are derived from carbonic acid—that can be produced through the polycondensation of diols with phosgene, although transesterification of diols, commonly hexane diol, with a carbonic acid ester, such as diphenylcarbonate.

Acrylic polyol for use in the present disclosure include, but are not limited to, those obtained by radical copolymerization of acrylic monomers (ternary or quaternary copolymers), such as acrylic or methacrylic acids and esters. The source of hydroxyl groups in these acrylic polyols is the utilization in the radical copolymerization reaction of hydroxyalkyl acrylates or hydroxyalkyl methacrylates as comonomers. Generally, the radical copolymerization reactions of acrylic comonomers are performed in an adequate solvent, by dropwise addition of monomer—initiator (peroxides) mixture.

The polyfunctional amine for use in the present disclosure may include polyether polyamine or polyester polyamine.

In a preferred embodiment, the isocyanate reactive composition is polyester polyol or an acrylic polyol.

Catalysts which enhance the formation of urethane and urea bonds may be used, for example, tin compound, such as a tin salt of a carboxylic acid, e.g., dibutyltin dilaurate, stannous acetate and stannous octoate; amines, e.g., dimethylcyclohexylamine and triethylene diamine.

Two or more different catalysts can be used in the process of the present disclosure. In one embodiment, the proportion of the catalysts present in the composition is in an amount ranging from 0.001 to 5 wt %, preferably from 0.01 to 2 wt % based on the total weight of the polyurethane composition.

According to one embodiment, the NCO index of the polyurethane composition is in the range of from about 0.8 to about 2, preferably from about 1.05 to about 1.5.

The isocyanate index or NCO index or index is the ratio of NCO-groups over isocyanate-reactive hydrogen atoms present in a formulation.

[NCO]

[Active Hydrogen]

In other words, the NCO-index expresses the amount of isocyanate actually used in a formulation with respect to the amount of isocyanate theoretically required for reacting with the amount of isocyanate-reactive hydrogen used in a formulation.

In another embodiment, the polyurethane composition may further optionally comprise fire retardants, antioxidants, solvents, surfactants, chain extender, crosslinking agent, fillers, pigments, or any other typical additives used in PU materials.

Advantages of the disclosed composition may include: (1) high flexibility; (2) improved impact resistance; and (3) environmentally friendly.

The present disclosure also provides a process for making the polyurethane composition, comprising adding isocyanate reactive composition to a polyfunctional isocyanate composition.

Furthermore, the present disclosure also provides the method of using the polyurethane compositions to form a coating product.

In addition, the present disclosure also provides a coating product comprises the polyurethane composition of the present disclosure.

The examples which now follow should be considered exemplary of the present disclosure, and not delimitive thereof in any way.

Raw Materials
Polyetheramine: JEFFAMINE® EDR 176 polyfunctional ether amine (Supplier: Huntsman Corporation, USA);
HDI A: WANNATE® HT-100 1,6-hexamethylene diisocyanate based polyisocyanate (Supplier: Wanhua Chemical Group, China);
HDI B: DESMODUR® N75 aliphatic polyisocyanate (Supplier: Covestro, Germany)
Polyol A: SETALUX® 1907 BA-75 acrylic polyol (Supplier: Allnex Group, Germany);
Polyol B: DESMOPHEN® 651 MPA/X polyester polyol; has an OH content 5.5% (Supplier: Covestro, Germany);
Catalyst: dibutyltin dilaurate

Preparation of Ether Isocyanate ISO228

18 ml Polyetheramine dissolved in 120 ml mono chlorobenzene (MCB) was added slowly to a reactor containing a 10° C. cooled solution of 29.67 g triphosgene in 210 ml MCB. The reaction temperature was increased to 80° C. and kept for 4 hours and followed by reflux for another 4 hours. The mixture was separated by filtration after static cooling. The obtained filtrate was fractionated under vacuum to remove MCB and then the residual liquid was distilled to obtain a transparent liquid which comprising ether isocyanate with a structure of formula (III).

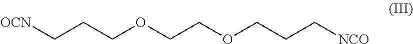

Preparation of Polyisocyanate Composition A

A four-neck flask equipped with a stirrer, a thermometer, a reflux pipe, and a nitrogen inlet tube was charged with 160 parts by weight of ISO 228, 48 parts by weight of xylene as solvent and 0.6 parts by weight of tetra butyl ammonium acetate as the catalyst, and reacted at 60° C. The reaction was continued until the conversion rate of the isocyanate group reached 20%. Then, the reaction was terminated by adding equal mole of H₃PO₄ to catalyst. The reaction mixture was allowed to go through vacuum distillation to remove unreacted ISO 228 to obtain a polyisocyanate composition A containing trimer product with a structure of formula (I).

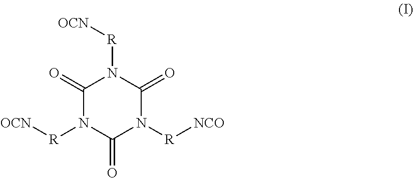

### R is

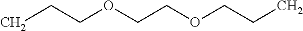

Preparation of Polyisocyanate Composition B

A four-neck flask equipped with a stirrer, a thermometer, a reflux pipe, and a nitrogen inlet tube was charged with 114 parts by weight of ISO 228 and 1.8 parts by weight of deionized water and reacted at 100° C. for 1.5 hours and 130° C. for 3.5 hours. The reaction was continued until the conversion rate of the isocyanate group reached 15.1%. Then, the reaction was terminated. The unreacted isocyanate was removed by vacuum distillation at 130° C., to obtain polyisocyanate composition B containing biuret product with a structure of formula (II).

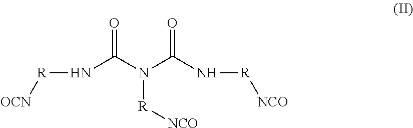

### R is

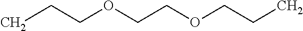

### Examples 1-6

The components for Examples 1 through 6 are shown in Table 1. All values listed in Table 1 refer to parts by weight. As shown in Table 1, Examples 5 and 6 were comparative examples that contained polyisocyanates not from the present disclosure.

TABLE 1

| | Example | | | | | |
|---|---|---|---|---|---|---|
| Formulation | 1 | 2 | 3 | 4 | 5 | 6 |
| Polyisocyanate | 68 | 100 | | | | |
| Composition A | | | | | | |
| Polyisocyanate | | | 72 | 105 | | |
| Composition B | | | | | | |
| HDI A | | | | | 45 | |
| HDI B | | | | | | 60 |
| Polyol A | 100 | | 100 | | 100 | 100 |
| Polyol B | | 100 | | 100 | | |
| Catalyst | 0.1 | 0.1 | 0.1 | 0.1 | 0.1 | 0.1 |

Procedure

For Examples 1-6, the components were mixed in the proportion according to Table 1 and at an index of 1.1. The mixture of each example was applied on a standard tin test plate with a wet coat thickness about 100 μm, and the coat was dried at 60° C. for 30 minutes. The coat was cured for 7 days at room temperature before being tested.

Results

Impact Resistance Performance and Physical Property

TABLE 2

| Example | 1 | 2 | 3 | 4 | 5 | 6 |
|---|---|---|---|---|---|---|
| Hardness ¹⁾ [cycles] | 20 | 30 | 10 | 20 | 110 | 85 |
| Flexibility ²⁾ | P | P | P | P | F | P |
| Impact resistance ³⁾ | >100 | >100 | >100 | >100 | 65 | 80 |
| [kgf · cm] | | | | | | |

¹⁾ Tested according to ASTM D4366 using König pendulum hardness tester
²⁾ Tested according to ASTM D522 by mandrel bend test with rod diameter of 2 mm
³⁾ Tested according to ASTM D2794
P = test passed;
F = test failed

Table 2 shows the impact resistance performance and physical property for Examples 1-6.

When polyisocyanate of the present disclosure is present (Examples 1-4), there is a significant improvement of impact resistance and decrease of the hardness of the coating.

What is claimed is:

1. A polyfunctional isocyanate composition comprising a polyfunctional isocyanate compound which is a derivative of an ether based diisocyanate; wherein the functionality of the polyfunctional isocyanate compound is 3.

2. The polyfunctional isocyanate composition of claim 1, wherein the polyfunctional isocyanate compound has the formula (I) or (II): 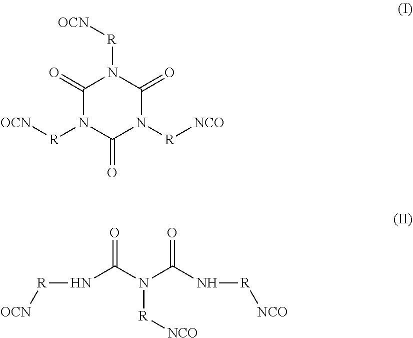
wherein
each R is independently of one another selected from a combination of linear, branched, saturated, unsaturated, cyclic and/or non-cyclic aliphatic hydrocarbons containing at least one ether group, and mixtures thereof.

3. The polyfunctional isocyanate composition of any one of claims 1 to 2 wherein R is linear aliphatic hydrocarbon containing two ether groups.

4. A polyurethane composition comprising:
(a) a polyfunctional isocyanate composition of claims 1 to 3; and
(b) an isocyanate reactive composition.

5. The polyurethane composition of claim 4 wherein the resin composition has an NCO index in the range from about 0.8 to about 2, preferably from about 1.05 to about 1.5.

6. The polyurethane composition of any one of claims 4 to 5 wherein the isocyanate reactive composition comprising a polyfunctional polyol and/or a polyfunctional amine, preferably a polyfunctional polyol, and more preferably a polyester polyol and/or an acrylic polyol.

7. The polyurethane composition of any one of claims 4 to 6, wherein the polyurethane composition further comprises a catalyst.

8. A process for making the polyurethane composition of any one of claims 4 to 7, comprising adding isocyanate reactive composition to a polyfunctional isocyanate composition.

9. A method of using the polyurethane compositions of any one of the claims 4 to 7 to form a coating product.

10. A coating product comprises the polyurethane composition of any one of the claims 4 to 7.
